(19) United States
(12) Patent Application Publication
(10) Pub. No.: US 2018/0285709 A1
(43) Pub. Date: Oct. 4, 2018

(54) TRANSPONDER-UNIT FOR FACILITATING AUTHORIZATION ASSOCIATED WITH AN ARTICLE

(71) Applicant: Kim Braunstein, Frankfort, IL (US)

(72) Inventor: Kim Braunstein, Frankfort, IL (US)

(21) Appl. No.: 15/939,213

(22) Filed: Mar. 28, 2018

Related U.S. Application Data
(60) Provisional application No. 62/477,790, filed on Mar. 28, 2017.

(51) Int. Cl. G06K 19/077; G06K 7/00; G06K 19/07; G07C 9/00

(52) U.S. Cl. CPC G06K 19/07749; G07C 9/00111; G06K 19/0723; G06K 7/0008

(57) ABSTRACT

Disclosed is a transponder-unit for facilitating authorization associated with at least one article is provided. The transponder-unit may include a planar base including a planar cavity. Further, the planar cavity may include a transponder configured to transmit at least one identifier associated the at least one article. Further, the planar cavity may include a processor configured to process data. Further, the planar cavity may include a battery configured to provide power to operate at least one component of the transponder-unit. Further, the planar cavity may include an antenna array configured to provide wireless communication with a transponder registration system. Further, the transponder-unit may include an affixing means configured to attach the transponder-unit to a container including the at least one article. Further, the transponder-unit may include a static indicium including a static display surface. Further, the transponder-unit may include an electrical information upload port communicatively coupled to the processor.

The current application claims a priority to the U.S. Provisional Patent application Ser. No. 62/477,790 filed on Mar. 28, 2017.

### FIELD OF THE INVENTION

The present invention relates generally to: a transponder and decal system and apparatus that is used to collect, provide, and secure data and information indices concerning authorization and location of an article including, but not limited to, a container that requires such authorization to operate lawfully in a jurisdiction having authority further communicating data to one of its partner technology providers including, but not limited to, block chain technology, to create a more efficient and secure platform for organizing global trade. The present invention relates generally to the transportation of goods. In particular, the present invention relates to a transponder-unit to secure and provide an indication concerning authorization of an article being transported.

### BACKGROUND OF THE INVENTION

The transportation of goods, a major commercial global activity valued at over 4 Trillion dollars a year is subject to a vast number of regulations. A tremendous amount of duplicative clerical effort is currently required for verification and inspection of goods/articles to ensure that the goods/articles are transported as per the regulations of the one or more jurisdictions they traverse through.

Accordingly, the verification of the authority, authenticity, ownership, and scope of jurisdiction in the transport of registered goods/articles, notably registered intermodal containers, experiences a wide gap amidst ever increasing global demands of this verified information to be communicated between countries and local jurisdictions. On the other hand, the means and mechanisms of travel short and long continue to improve.

The conventional systems and processes do not have or offer readily accessible information of a container's ownership, contents, route traveled and authenticity of registration. The failure to recognize an infraction or lack of authorization further presents a breach of regulations, security, and protocol. The Authority having jurisdiction would expect and require Article(s) to lawfully operate and traverse from one place to another. However, the conventional systems for verification may invoke a lengthy or cumbersome investigation of such verification through authorized singular entities individually checking and verifying through any number of chains of command and employing methods to verify the containers lawful authenticity and authority in the jurisdiction it presently occupies.

Accordingly, there is a need for improved systems and methods of facilitating authorization associated with articles/containers/chassis that may also overcome one or more of the abovementioned problems and/or limitations.

### SUMMARY OF THE INVENTION

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

Disclosed is a transponder-unit for facilitating authorization associated with at least one article. The “at least one article” may include one or more articles/containers/chassis. The transponder-unit may include a planar base including a planar cavity. Further, the planar cavity may include a transponder configured to transmit at least one identifier associated with the article/container/chassis. Further, the planar cavity may include a processor configured to process data. Further, the planar cavity and/or planar base may include a battery and/or any energy generating equipment including, but not limited to, solar cells and/or wind turbine that may also be exterior mounted or integral to the transponder—this energy generating equipment will be configured to provide power to operate at least one component of the transponder-unit. Further, the planar cavity may include an antenna array configured to provide wireless communication with a transponder registration system. Further, the antenna array may be communicatively coupled to the processor. Further, the transponder-unit may include an affixing means configured to attach the transponder-unit to article/container/chassis. Further, the transponder-unit may include a static indicium that may include a static display surface. Further, the transponder-unit may include an electrical information upload port communicatively coupled to the processor. Further, the electrical information upload port may be configured to interface with an external electronic device. Further, the transponder-unit may also include LED/OLED type lighting on any portion of the transponder-unit. The LED/OLED lighting may change colors to indicate status of the authority to traverse wherever a geo-fence or a set of geographical boundaries is/are set up. Further, the transponder-unit may also include a sensor or sensors that will collect data and transmit it to the system integrator further integrating thus data into one of its partner technologies, including but not limited to block chain technology. This type of data may include, but is not limited to, gamma, chemical, atmosphere, temperature inside and outside of the container, and/or additional commercially marketable information.

Also disclosed is a method of facilitating authorization associated with article/container/chassis. The method may include receiving, using a communication device, at least one identifier associated the article/container/chassis from a transponder-unit attached to a container comprising the article/container/chassis. Further, the transponder-unit may include a static indicium including a static display surface including a visual representation of an authorization information associated with the article/container/chassis. Further, the at least one identifier may include an electronic representation of the authorization information. Further, the method may include receiving, using the communication device, a geolocation from the transponder-unit. Further, the geolocation may be determined by a location sensor comprised in the transponder-unit. Further, the method may include generating, using a processing device, an audit data corresponding to at least one of the article/container/chassis based on the geolocation and the at least one identifier. Further, the method may include utilizing a computer/communications/storage device, the underlying processing audit data utilizing block-chain or other secure technology. Further, the method may include receiving, using the communication device, a request from a user device. Further, the method may include retrieving, using the storage device, the audit data. Further, the method may include transmitting, using the communication device, the audit data to the user device.

According to some embodiments, the present disclosure relates to a transponder system and apparatus that may be used to secure and provide an indication concerning authorization of an article/container/chassis, particularly a container that requires such authorization to operate lawfully in a jurisdiction having authority.

Further, the present disclosure seeks to assuage the burden and tedium of operation of checking and verifying article/container/chassis. This may include attaching one or more of tags, decals and transponder units onto the article/container/chassis. Further, a transponder registration system, authorized by the respective authority having jurisdiction, may assist in streamlining the means of verification of articles/containers/chassis passing through or operating within certain jurisdictions and may additionally note the location of the articles/containers/chassis presently through a satellite, cellular, or RFID and near field communication (to allow containers and/or reading devices to network with blockchain or other secure data communication or other transmitted data.

Further, the present disclosure may also allow Jurisdiction Having Authority (JHA) to assess additional security issues from the data they receive, along with having the ability to invoice for associated usage of the disclosed system.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of a platform consistent with various embodiments of the present disclosure.

FIG. 2A is a side view of a cargo chassis carrying an intermodal container with a transponder-unit installed on the rear side of the intermodal container in accordance with an exemplary embodiment.

FIG. 2B is a rear view of the cargo chassis carrying the intermodal container with the transponder-unit installed on the rear side of the intermodal container in accordance with an exemplary embodiment.

FIG. 3 illustrates a bill of lading (BOL) with a decal in accordance with an exemplary embodiment.

FIG. 4 is a perspective view of the transponder-unit in accordance with an exemplary embodiment.

FIG. 5 is a front view of the transponder-unit in accordance with an exemplary embodiment.

FIG. 6 is a block diagram of the transponder-unit for facilitating authorization associated with article/container/chassis in accordance with some embodiments

FIG. 7 illustrates an exemplary computing system that may be employed to implement processing functionality for various embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of transporting goods, embodiments of the present disclosure are not limited to use only in this context.

### Overview

According to some embodiments, the present disclosure relates to a transponder system and network that allows the immediate assessment of authenticity of the decal(s), tag(s), and transponders, and thus the article/container/chassis it is secured upon through a transponder-unit and a transponder registration system within the jurisdiction having authority. The transponder-unit may include one or more of a planar base, an affixing means, a static indicium, an optional electrical indicium, and an electrical information upload port. The planar base may include a planar cavity, which may further include one or more of a transponder, a processor, a battery (and/or solar cells), and an antenna array. The static indicium may include a static display surface. Further, the optional electrical indicium may include an electrical display surface that may further include status indicator lights also confirming registration status of the article/container/chassis. The transponder registration system may further include a wireless network. The wireless network may include one or more of a satellite network, a local network, receiver stations and/or a personal computing device. A central receiving station may receive data as one or more of Distributed Ledger Technology (DLT), Blockchain Technology or other secured data processing technologies, and or Smart Contracts.

Further, the transponder-unit may be a physical apparatus of the system that is secured to an article/container/chassis of varying size, make, model, origin, and destination. The transponder-unit may be formed of a shape and geometry that is conspicuous to the casual observer such that it may protrude outward from article/container/chassis including but not limited to rectilinear, curvilinear, trilinear, polygonal and other such geometry profiles that protrude outward from the surface the transponder-unit is affixed to.

Further, the planar base that houses the transponder inside of the planar cavity, may also include indication lighting, and battery with optional solar or other recharging apparatus. The planar base may utilize a surface geometry consistent with any shape such as curvilinear, rectilinear, trilinear, polygonal and so on where any plurality of lateral walls may be established at an arbitrary lateral length of a protrusion. However, the front surface may remain relatively flat or flush to the surface the apparatus is affixed upon to allow the clear display of static, or optional electrical indicium. Additionally, the planar base may provide for a waterproof, preferably air tight seal of the electronic components within and may be produced of any number of materials including metals, plastics, rubbers, and so on. The planar cavity may be located within the planar base near the center of the apparatus. The planar cavity may house one or more of the transponder, the processor, the battery and/or solar and other charging apparatus, and the antenna array therein. The planar cavity may be preferably enclosed fully without a particular aperture to allow the full securing of the contents, data, and authorization held therein.

Further, the transponder may be located arbitrarily within the planar cavity and may comprise technologies including, but not limited to, radio-frequency identification (RFID) and near field communication (NFC) which allow communication between containers and or reading devices, electronic tags, cellular, global positioning system (GPS) devices, and so on. The transponder may provide the means and storage of ranged identification on the apparatus as well as optionally allowing for geolocation means of locating the apparatus and likewise the article/container/chassis the apparatus is affixed to. A processor may be configured for uploading information, and the outputting of an authorized signal available to the jurisdiction having authority, as well as facilitating power consumption and processing signals requesting for information such as where geolocation may be utilized. A battery (and/or wind turbine, or solar cells) may provide broadcasting power for the transponder and antenna array and processing power to the processor. Further, the apparatus may be multi-use and may be reconfigurable through the electric information upload post. Further, the battery/batteries may be resupplied with a recharging means through solar, wind, or cable means to a power port or the electric information upload port or other recharging means. Further, the planar base may be comprised of a battery aperture that allows retrieval and insertion of the battery into the planar base. The antenna array may be connected to and may be adjacent to the transponder that enables long-range communication between the apparatus and the wireless network. The transponder may additionally note the use of battery or mileage to store into the processor as determined through a time of use and geolocation by satellite to determine the expiration of the apparatus in addition to an arbitrary time. The transponder may possess the ability to be upgraded with sensors such as gamma or alpha detectors, temperature sensors, tamper sensors, chemical sensors, and so on to assist in knowing the condition and state of the article/container/chassis that the apparatus is attached to.

Further, the affixing means may be provided on the rear of the apparatus to secure the apparatus to the article/container/chassis. The affixing means may include, but are not limited to, one or more of mechanical fasteners, magnetic affixing means, epoxy and adhesives, snap fits, and so on. Further, the apparatus may allow for verification of tampering with the affixing means. On the planar base surface opposite the side facing the article/container/chassis, the static indicium is provided. The static indicium may provide a static means of conveying authorization information such as, but not including, an expiration date, registration country, state, authority having jurisdiction and so on. The static display surface forming the static indicium may include a plurality of locations to note, fasten, secure, and display information concerning the authorization and purpose or ownership of the article/container/chassis and may allow for the direct transcription or inscription of information. There may be a replication of the static display on other areas of the article/container/chassis to eliminate the possibility of unknown relocation of the transponder. The duplicate tag or decal may be visible concurrent with the transponder or tag on the transponder.

Further, an optional electrical indicium may be provided to replace the static indicium to allow a more reusable apparatus where the data may be displayed through a plurality of electronic display surfaces in the form of screens where information is displayed as dictated by the processor. Accordingly, a plurality of electrical display surfaces may be provided in the optional electrical indicium, which may replace/compliment the static display surfaces. The electrical display surfaces may display information housed in the processor through series of screens that allow the apparatus to be reused after registering the apparatus in a different jurisdiction, name, or other means of ownership identification. The planar base may also include the electrical information upload port that may be connected to a means of charging or uplinked to an authorizing digital entity as authorized on a personal computing device. The electrical information port may include one or more of a USB port, a micro USB, an Ethernet port, and other means of data and power transfer.

The transponder registration system may allow for a network of authorized transponder-units to be available to a local jurisdiction, notably so where overseas travel may be involved in the transport of goods in containers or through intrastate or across state lines upon moving or trucking affixed containers. This may aid in local, state, or national security to the effect of tracking items moving throughout the country on a continual or continuous basis. A wireless network enables the apparatus to communicate along local wireless and internet channels, allowing the status of the apparatus to be determined and verified readily either by an extraneous scanning means in the local vicinity of the transponder-unit, a direct uplink to a personal computing device having authority of jurisdiction, and wireless verification of the geolocation and authenticity of the apparatus as monitored by a satellite link and verified through an extraneous wirelessly assessed personal computing device, or other earth located devices that would receive the transponder's data.

The satellite network may facilitate assessment across jurisdictions and country lines during movement and transport of the transponder-unit. Such satellite network connectivity may allow for the assessment of authenticity concerning the apparatus to be performed on a personal computing device and may provide geolocation means to monitor the movement and current location of the article/container/chassis the transponder-unit is secured to and may additionally include using cellular communication signals. This locating may assist the article/container/chassis owner in limiting the article/container/chassis's loss for additional insurance and security purposes. Further, an extraneous visual receiving/camera, or scanning device (similar to a bar scanner) may be used to view/scan the transponder-unit and or the decal(s) at the local level to verify the apparatus's authenticity, authority, or other property of ownership and means to operate the article/container/chassis the apparatus is affixed to. Local communications may additionally allow for the linking of multiple apparatuses to allow the assessment of an area through the evaluation of additional sensors. The personal computing device may further be used to verify the authenticity and the authority the transponder-unit possesses and the ownership thereof. The extraneous personal computing device may additionally provide means of displaying the current location or movement of the transponder-unit through the satellite network through a program once registered and authorized in the transponder registration system. The personal computing device may include, but not limited to, a computer, a cell phone, a smartphone, and a smartwatch.

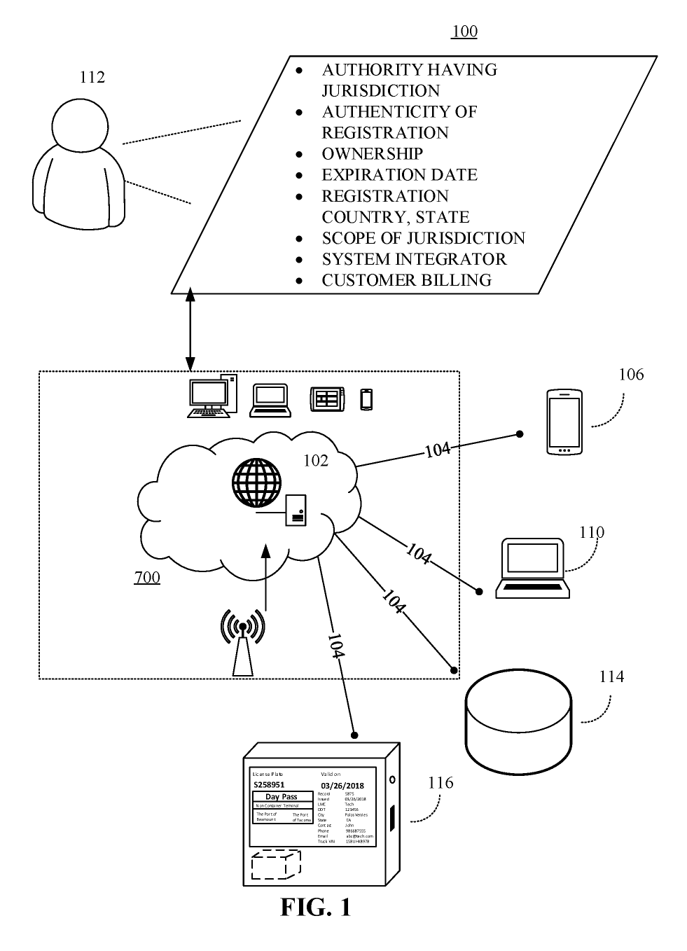

Referring now to figures, FIG. 1 is an illustration of a platform 100 consistent with various embodiments of the present disclosure. By way of non-limiting example, the online platform 100 for facilitating authorization associated with article/container/chassis may be hosted on a centralized server 102, such as, for example, a cloud computing service. The centralized server 102 may communicate with other network entities, such as, for example mobile devices 106 (such as a smartphone, a laptop, a tablet computer etc.), other electronic devices 110 (such as desktop computers, etc.), databases 114 (such as registration databases, regulatory databases), and a transponder-unit 116 via a communication network 104 such as, but not limited to, the Internet. Further, users of the platform may include one or more relevant parties such as employees of transport companies, employees of government agencies and system administrators. Accordingly, electronic devices operated by the one or more relevant parties may be in communication with the platform 100.

Further, the online platform 100 may also include a system integrator that may obtain data of the article/container/chassis and its route (such as inside a geo-fence). For example, an IBM or Accenture like company with a back-room earth station may operate the system integrator.

The transponder-unit 116 may include a decal with transcription of information. The information may also include details about a customer/shipper, that is a person/entity that issued or caused to be issued the bill of lading (BOL) and paid for the decal to be placed on the one or more of a chassis, a container, and a BOL.

A user 112, such as the one or more relevant parties, may access the platform 100 through a software application. The software application may be embodied as, for example, but not be limited to, a website, a web application, a desktop application, and a mobile application compatible with any computing device which may include smart phones 700.

In some embodiments, the container may be an intermodal container. The intermodal containers may be used across different modes of transport without unloading and reloading their cargo. The different modes of transport may include, but are not limited to, a truck, a train, an aircraft, and a ship. The intermodal containers are used to store and transport materials and products efficiently and securely across the globe.

According to some embodiments, the online platform may execute a method of facilitating authorization associated with article/container/chassis. The method may include receiving, using a communication device, at least one identifier associated the article/container/chassis from a transponder-unit attached to the respective article/container/chassis. Further, the transponder-unit may include a static indicium including a static display surface including a visual representation of an authorization information associated with the article/container/chassis. Further, the at least one identifier may include an electronic representation of the authorization information. Further, the method may include receiving, using the communication device, a geolocation from the transponder-unit. Further, the geolocation may be determined by a location sensor comprised in the transponder-unit. Further, the method may include generating, using a processing device, an audit data corresponding to at least one of the article/container/chassis based on the geolocation and the at least one identifier. Further, the method may include storing, using a storage device, the audit data using block-chain or other secured data communication technology. Further, the method may include receiving, using the communication device, a request from a user device. Further, the method may include retrieving, using the storage device, the audit data. Further, the method may include transmitting, using the communication device, the audit data to the user device.

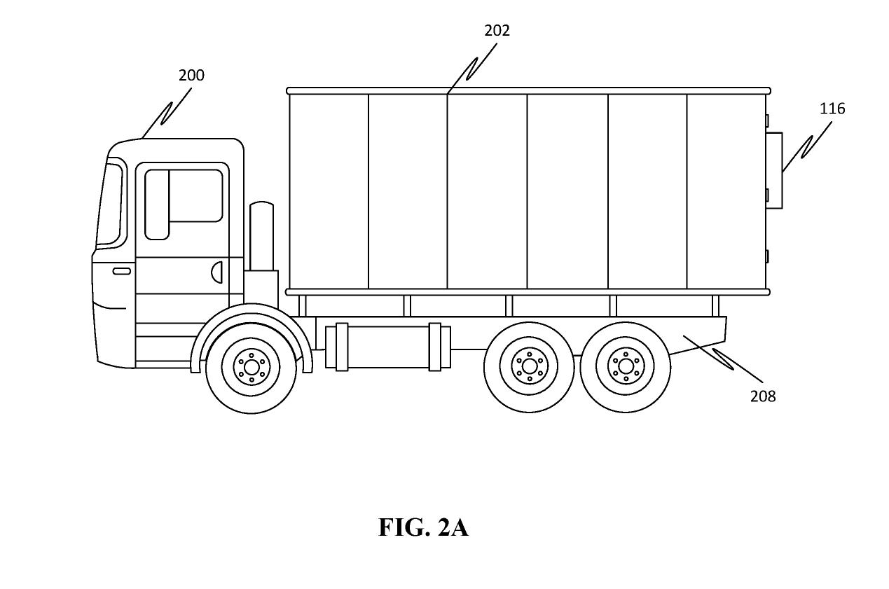

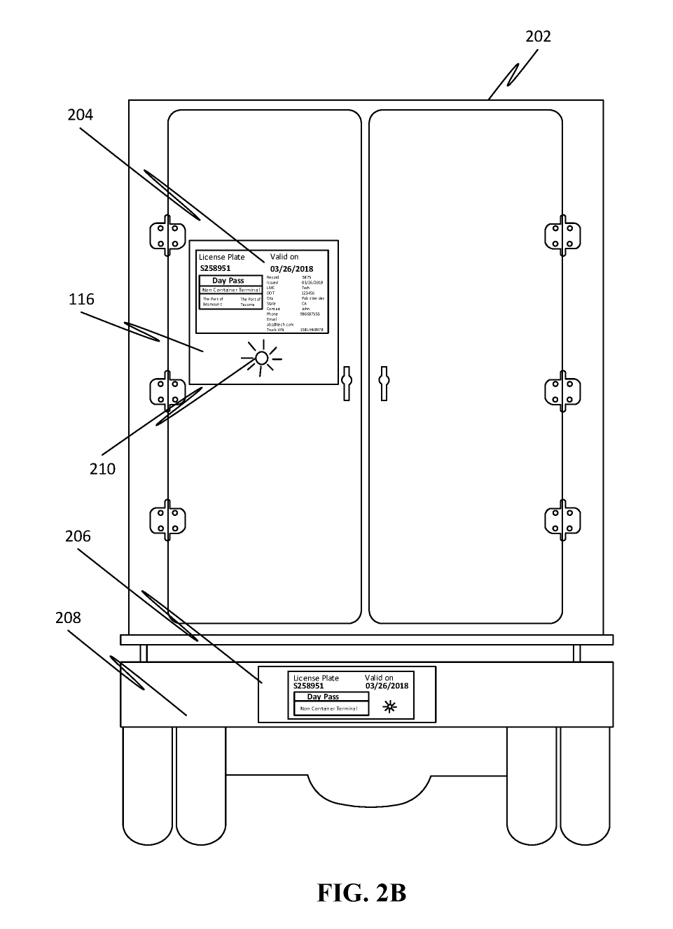

FIG. 2A is a side view of a cargo truck 200 carrying an intermodal container 202 (on a chassis/trailer 208) with a transponder-unit 116 installed on the rear side of the intermodal container 202 in accordance with an exemplary embodiment. FIG. 2B is a rear view of the cargo truck 200 carrying the intermodal container 202 (on a chassis/trailer 208) with the transponder-unit 116 installed on the rear side of the intermodal container 202. A shape and a size of the transponder-unit 116 may render the transponder-unit 116 conspicuous to a casual observer. For example, the transponder-unit 116 may protrude outward from the intermodal container 202. Accordingly, the shape of the transponder-unit 116 may include, but not limited to, rectilinear, curvilinear, trilinear, polygonal and other such geometry profiles that may protrude outward from a surface the transponder-unit 116 is affixed to. In FIG. 2A-B, the transponder-unit 116 is not drawn to scale.

Further, the transponder-unit 116 includes a static indicium 204 comprising a static display surface. The static indicium 204 may be printed on a decal, which may be affixed to the transponder-unit 116. The static indicium 204 may include one or more indicia. The one or more indicia may include authorization information related to one or more of the authority having jurisdiction, the authenticity of registration, ownership, an expiration date, registration country, state, and scope of jurisdiction of the intermodal container 202. In some embodiments, the static display surface may include a visual representation of the authorization information associated with the article/container/chassis. Further, the at least one identifier may include an electronic representation of the authorization information. In further embodiments, the static display surface may include two or more of locations configured to receive a transcription of information. In further embodiments, the two or more of locations may be configured to facilitate fastening of two or more physical information tags to the static display surface.

For example, a physical information tag in the two or more physical information tags may be fastened to static indicium 204 using a fastener, such as, but not limited to, VELCRO® strips clips, rope, screws, bolts, adhesive, wing-nuts, magnets, etc.

The transponder-unit 116 may also include an LED/OLED 210. The LED/OLED 210 may change colors to indicate status of the authority to traverse wherever a geo-fence is set up. The LED/OLED 210 may be powered by battery 506. Further, the LED/OLED 210 may be powered based on the control signals from processor 504. For example, the LED/OLED 210 may indicate the status of the authority at night, when the static indicium 204 is not clearly visible. A green light (from the LED/OLED 210) may indicate that the article/container/chassis is authorized. Further, multiple LED/OLEDs may be placed around the housing of the transponder-unit 116.

Further, a static indicium 206 may be placed on a chassis 208 of the cargo truck 200. For example, the static indicium 206 may be printed on a decal, which may be affixed to the chassis 208.

Further, a transponder-unit with the static indicium 206 may be placed on the chassis 208 of the cargo truck 200. For example, the transponder-unit may be removably attached to the chassis 208. For example, the transponder-unit may be secured with a safety strap or screw to assist a magnetic mounting. Therefore, when the chassis 208 is supporting a container, the transponder-unit may be removed from the chasses 208 and attached to the container.

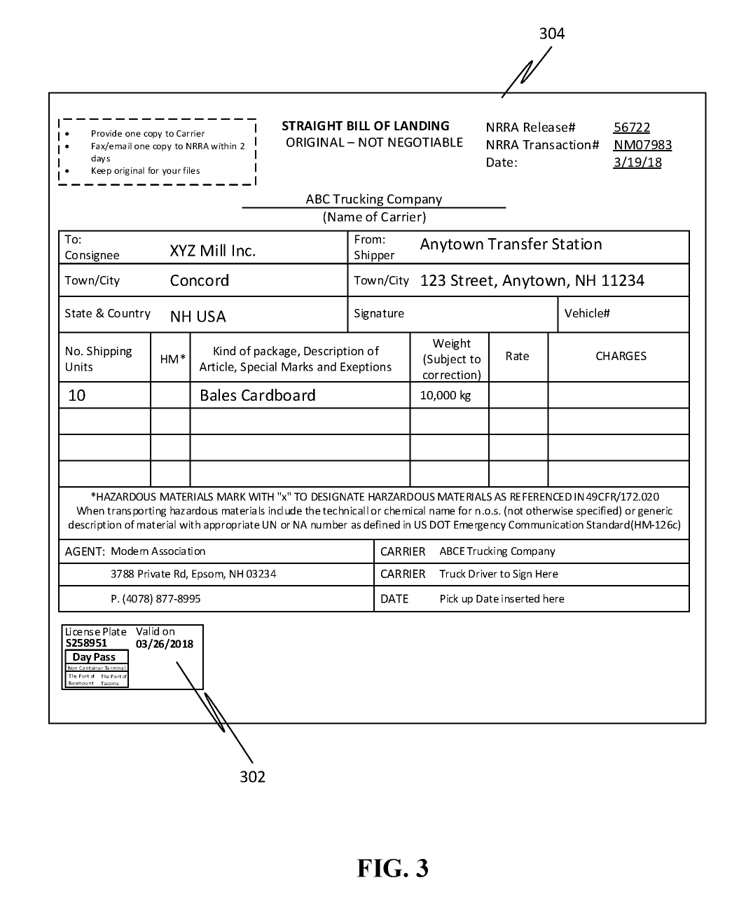

Yet further, a static indicium 302 may be placed on a bill of lading (BOL) 304 related to the shipment carried by the cargo truck 200, as shown in FIG. 3. For example, the static indicium 302 may be printed on a decal, which may be affixed to the BOL 304.

One or more of the static indicium 206 and the static indicium 302 may include one or more of the authority having jurisdiction, the authenticity of registration, ownership, an expiration date, registration country, state, and scope of jurisdiction of the intermodal container 202.

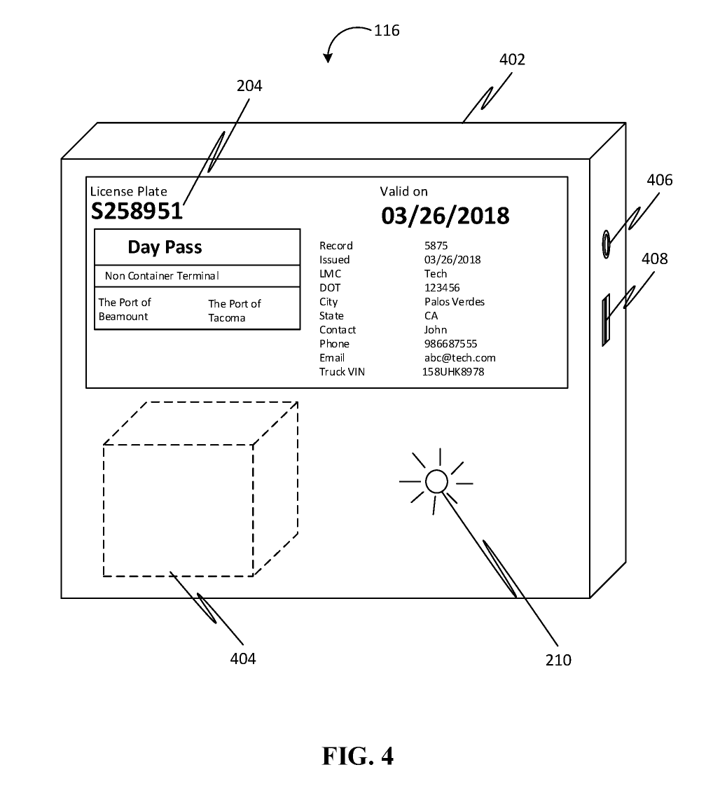

FIG. 4 is a perspective view of the transponder-unit 116 in accordance with an exemplary embodiment. Further, the transponder-unit 116 may include a planar base 402 comprising a planar cavity 404. The dotted lines indicate that the planar cavity 404 may be entirely/partially embedded within the planar base 402. Further, the transponder-unit 116 may include an affixing means configured to attach the transponder-unit 116 to the intermodal container 202. The affixing means may include one or more of VELCRO® strips clips, screws, bolts, adhesive, wing-nuts, magnets, epoxy, snap fits etc. Further, the affixing means may include a tamper detector configured to detect and indicate tampering of the affixing means subsequent to attaching the transponder-unit 116 to the intermodal container 202. Further, the affixing means may be configured to removably attach the transponder-unit 116 to the intermodal container 202.

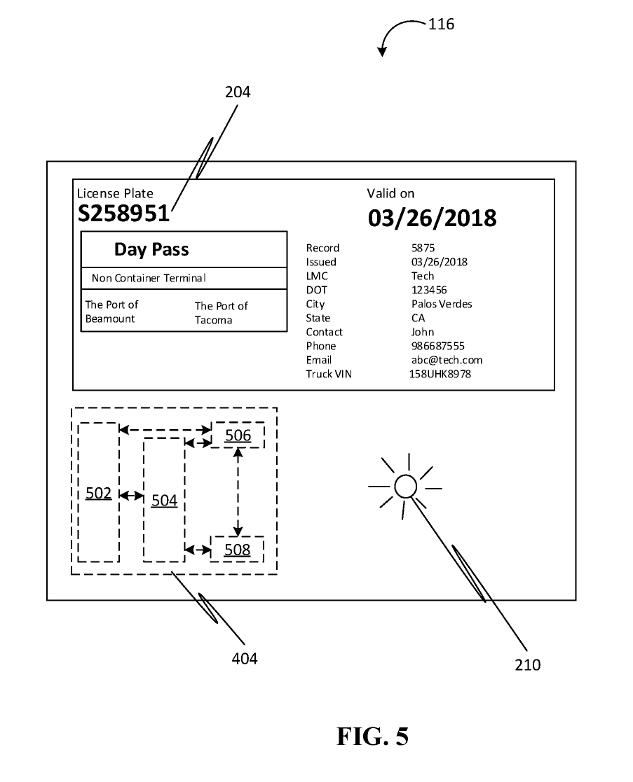

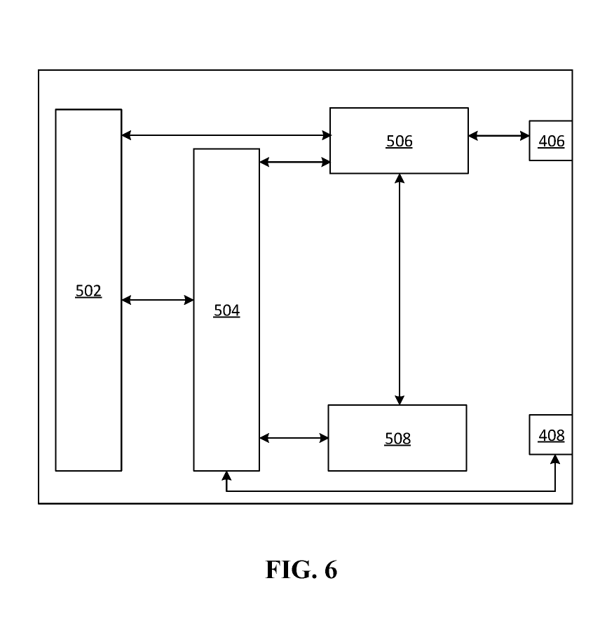

The planar cavity 404 may include a transponder 502, a processor 504, a battery 506 (and/or solar cells) and an antenna array 508, as shown in FIGS. 5-6. FIG. 5 is a front view of the transponder-unit 116 in accordance with an exemplary embodiment. FIG. 6 is a block diagram of the transponder-unit 116 in accordance with some embodiments. The transponder 502 may be configured to transmit at least one identifier associated the article/container/chassis (such as the intermodal container 202). The transponder 502 may include one or more of an RFID and NFC (which allow communication between containers and or reading devices), an electronic tag, a cellular device, and a geolocation sensor. The processor 504 may be configured to process data. The battery 506 may be configured to provide power to operate one or more components of the transponder-unit 116. The one or more components may include the transponder 502, the processor 504, the battery 506 and the antenna array 508. The antenna array 508 may be configured to provide wireless communication with a transponder registration system, wherein the antenna array 508 is communicatively coupled to the processor 504. The transponder registration system may be hosted on the centralized server 102.

Further, the planar base 402 may be configured to provide a waterproof and air tight seal for one or more components housed within the planar base 402. Yet further, the planar base 402 may include a battery aperture (not shown) configured to facilitate retrieval of the battery 506 from the planar base 402 and insertion of the battery 506 into the planar base 402. The battery aperture may be used to replace the battery 506 when required. Moreover, the planar base 402 may include a charging port 406 electrically coupled to the battery 506, wherein the charging port 406 may be configured to interface with an external energy providing device. Therefore, the charging port 406 may be used for charging the battery 506 using external power.

Further, the transponder-unit 116 may include an electrical information upload port 408 communicatively coupled to the processor 504. The electrical information upload port 408 may be configured to interface with an external electronic device. For example, the external electronic device may be used to store and/or retrieve the information from the transponder-unit 116. For example, the information may be related to one or more of the authority, the authenticity of registration, ownership, and scope of jurisdiction of the intermodal container 202. Further, the electrical information upload port 408 may be electrically coupled to the battery 506. Further, the electrical information upload port 408 may be configured to interface with an external energy providing device. This may help in charging the battery using external power. Therefore, the electrical information upload port 408 may be used for charging the battery 506 using external power. For example, the electrical information upload port 408 may include one or more of a USB port, a micro USB, an Ethernet, port and other means of data and power transfer.

In further embodiments, the transponder-unit 116 may include one or more sensors configured to detect one or more physical variables associated with the one or more of the transponder-unit 116 and the article/container/chassis. The one or more sensors may be communicatively coupled to the processor 504. For example, the one or more sensors may include a gamma detector, an alpha detector, temperature detector, tamper detector, and a chemical sensor. Further, the transponder-unit 116 may include one or more sensor ports configured to detachably interface with the one or more sensors, wherein the one or more sensor ports may be communicatively coupled to the processor 504.

In further embodiments, the transponder-unit 116 may include a location sensor configured to determine a geolocation of the transponder-unit 116. The location sensor may be communicatively coupled to the processor 504. Further, the processor 504 may be configured to calculate a mileage associated with the transponder-unit 116 based on the geolocation.

In some embodiments, the transponder-unit 116 may further include an electrical indicium (not shown) including an electrical display surface communicatively coupled to the processor 504.

In some embodiments, the transponder-unit 116 may further include one or more light emitters configured to generate light radiation. Further, the one or more light emitters may be communicatively coupled to the processor 504. Further, the light radiation may correspond to at least one status associated with one or more of the transponder-unit 116, the intermodal container 202 and the article/chassis. For example, the intermodal container 202 may include the article.

In some embodiments, the transponder-unit 116 may further include a bracket (not shown) configured to facilitate grasping of the transponder-unit 116 with a human hand.

In some embodiments, the transponder may be further configured to wirelessly receive an adjacent identifier associated with an adjacent article comprised in an adjacent article/container/chassis. Further, the antenna array may be further configured to wirelessly communicate the adjacent identifier to the transponder registration system. Accordingly, in an instance, an adjacent transponder-unit may be attached to the adjacent article/container/chassis. Further, in some instances, the adjacent transponder-unit may be configured similar to the transponder-unit described earlier. Accordingly, in an instance where the article/container/chassis and the adjacent article/container/chassis are co-located, a communication link may be established between the transponder-unit and the adjacent transponder-unit. For example, in an instance, the article/container/chassis may be stacked over the adjacent article/container/chassis. As a result, wireless radiation from an adjacent transponder comprised in the adjacent transponder-unit may not be able to reliably reach the transponder registration system. However, the transponder-unit may be able to wirelessly receive the adjacent identifier and subsequently transmit the adjacent identifier to the transponder registration system. As a result, in some cases, such as when multiple articles/containers/chassis are stacked together, due to formation of a chained communication link between adjacent articles/containers/chassis, the transponder registration system may be able to reliably receive multiple identifiers corresponding to the multiple transponder-units attached to the multiple articles/containers/chassis.

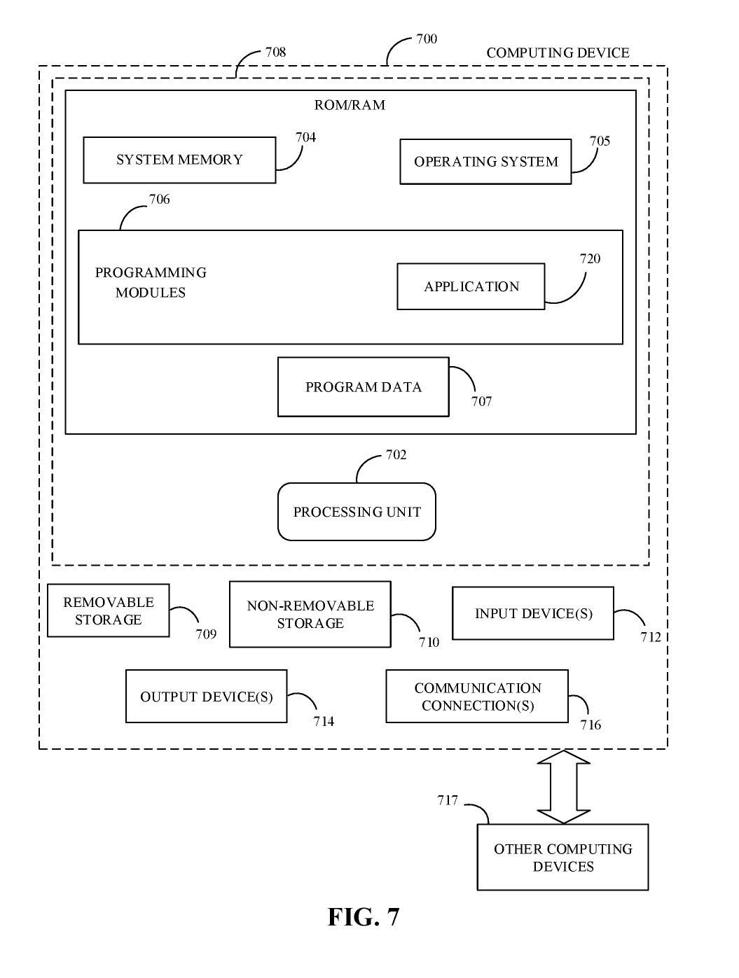

FIG. 7 is a block diagram of a system including computing device 700. Consistent with an embodiment of the disclosure, the aforementioned memory storage and processing unit may be implemented in a computing device, such as computing device 700 of FIG. 7. Any suitable combination of hardware, software, or firmware may be used to implement the memory storage and processing unit. For example, the memory storage and processing unit may be implemented with computing device 700 or any of other computing devices 718, in combination with computing device 700. The aforementioned system, device, and processors are examples and other systems, devices, and processors may comprise the aforementioned memory storage and processing unit, consistent with embodiments of the disclosure.

With reference to FIG. 7, a system consistent with an embodiment of the disclosure may include a computing device or cloud service, such as computing device 700. In a basic configuration, computing device 700 may include at least one processing unit 702 and a system memory 704. Depending on the configuration and type of computing device, system memory 704 may comprise, but is not limited to, volatile (e.g. random-access memory (RAM)), non-volatile (e.g. read-only memory (ROM)), flash memory, or any combination. System memory 704 may include operating system 705, one or more programming modules 706, and may include a program data 707. Operating system 705, for example, may be suitable for controlling computing device 700's operation. Accordingly, in some embodiments, the programming modules 706 may be implemented using one or more of software and hardware.

Furthermore, embodiments of the disclosure may be practiced in conjunction with a graphics library, other operating systems, or any other application program and is not limited to any particular application or system. This basic configuration is illustrated in FIG. 7 by those components within a dashed line 708.

Computing device 700 may have additional features or functionality. For example, computing device 700 may also include additional data storage devices (removable and/or non-removable) such as, for example, magnetic disks, optical disks, or tape. Such additional storage is illustrated in FIG. 7 by a removable storage 709 and a non-removable storage 710. Computer storage media may include volatile and nonvolatile, removable and non-removable media implemented in any method or technology for storage of information, such as computer-readable instructions, data structures, program modules, or other data. System memory 704, removable storage 709, and non-removable storage 710 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 700. Any such computer storage media may be part of device 700. Computing device 700 may also have input device(s) 712 such as a keyboard, a mouse, a pen, a sound input device, a touch input device, etc. Output device(s) 714 such as a display, speakers, a printer, etc. may also be included. The aforementioned devices are examples and others may be used.

Computing device 700 may also contain a communication connection 716 that may allow device 700 to communicate with other computing devices 718, such as over a network in a distributed computing environment, for example, an intranet or the Internet. Communication connection 716 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 704, including operating system 705. While executing on processing unit 702, programming modules 706 (e.g., application 720) may perform processes including, for example, one or more stages of methods, algorithms, systems, applications, servers, databases as described above. The aforementioned process is an example, and processing unit 702 may perform other processes.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example, but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may, in fact, be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention.

What is claimed is:

1. A transponder-unit for facilitating authorization associated with at least one article, the transponder-unit comprising:
a planar base comprising a planar cavity, wherein the planar cavity comprises:
a transponder configured to transmit at least one identifier associated the at least one article;
a processor configured to process data;
a battery configured to provide power to operate at least one component of the transponder-unit;
an antenna array configured to provide wireless communication with a transponder registration system, wherein the antenna array is communicatively coupled to the processor;
an affixing means configured to attach the transponder-unit to a container comprising the at least one article;
a static indicium comprising a static display surface; and
an electrical information upload port communicatively coupled to the processor, wherein the electrical information upload port is configured to interface with an external electronic device.

2. The transponder-unit of claim 1 characterized by a shape and a size that renders the transponder-unit conspicuous to a casual observer.

3. The transponder-unit of claim 1, wherein the planar base is further configured to provide a waterproof and air tight seal for at least one component housed within the planar base.

4. The transponder-unit of claim 1, wherein the transponder comprises at least one of an RFID and near field communication to allow communication between containers and/or reading devices, an electronic tag, a cellular device and a geolocation sensor.

5. The transponder-unit of claim 1, wherein the planar base comprises a battery aperture configured to facilitate retrieval of the battery from the planar base and insertion of the battery into the planar base.

6. The transponder-unit of claim 1, wherein the planar base comprises a charging port electrically coupled to the battery, wherein the charging port is configured to interface with an external energy providing device.

7. The transponder-unit of claim 1, wherein the electrical information upload port is electrically coupled to the battery, wherein the electrical information upload port is configured to interface with an external energy providing device.

8. The transponder-unit of claim 1 further comprises at least one sensor configured to detect a physical variable associated with at least one of the transponder-unit and the at least one article, wherein the at least one sensor is communicatively coupled to the processor.

9. The transponder-unit of claim 8 further comprising at least one sensor port configured to detachably interface with the at least one sensor, wherein the at least one sensor port is communicatively coupled to the processor.

10. The transponder-unit of claim 8, wherein the at least one sensor comprises at least one of a gamma detector, an alpha detector and a chemical sensor.

11. The transponder-unit of claim 1 further comprising a location sensor configured to determine a geolocation of the transponder-unit, wherein the location sensor is communicatively coupled to the processor.

12. The transponder-unit of claim 11, wherein the processor is configured to calculate a mileage associated with the transponder-unit based on the geolocation.

13. The transponder-unit of claim 1, wherein the affixing means comprises a tamper detector configured to detect and indicate tampering of the affixing means subsequent to attaching the transponder-unit to the container.

14. The transponder-unit of claim 1, wherein the static display surface comprises a plurality of locations configured to receive transcription of information.

15. The transponder-unit of claim 14, wherein the plurality of locations is configured to facilitate fastening of a plurality of physical information tags to the static display surface.

16. The transponder-unit of claim 1 further comprising an electrical indicium comprising an electrical display surface communicatively coupled to the processor.

17. The transponder-unit of claim 1 further comprising at least one light emitter configured to generate light radiation, wherein the at least one light emitter is communicatively coupled to the processor, wherein the light radiation corresponds to at least one status associated with at least one of the transponder-unit, the container and the at least one article.

18. The transponder-unit of claim 1 further comprising a bracket configured to facilitate grasping of the transponder-unit with a human hand, wherein the affixing means is configured to removably attach the transponder-unit to the container.

19. The transponder-unit of claim 1, wherein the transponder is further configured to wirelessly receive an adjacent identifier associated with an adjacent article comprised in an adjacent container, wherein the antenna array is further configured to wirelessly communicate the adjacent identifier to the transponder registration system.

20. A method of facilitating authorization associated with at least one article, the method comprising:
receiving, using a communication device, at least one identifier associated the at least one article from a transponder-unit attached to a container comprising the at least one article, wherein the transponder-unit comprises a static indicium comprising a static display surface comprising a visual representation of an authorization information associated with the at least one article, wherein the at least one identifier comprises an electronic representation of the authorization information;
receiving, using the communication device, a geolocation from the transponder-unit, wherein the geolocation is determined by a location sensor comprised in the transponder-unit;
generating, using a processing device, an audit data corresponding to at least one of the at least one article and the container based on the geolocation and the at least one identifier;
storing, using a storage device, the audit data using block-chain technology;
receiving, using the communication device, a request from a user device;
retrieving, using the storage device, the audit data; and
transmitting, using the communication device, the audit data to the user device.
